(19) United States
(12) Patent Application Publication
(10) Pub. No.: US 2006/0205339 A1
(43) Pub. Date: Sep. 14, 2006

(54) Communication terminal

(75) Inventor: Kazunobu Kimura, Yokohama-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/367,568

(22) Filed: Mar. 6, 2006

(30) Foreign Application Priority Data
Mar. 8, 2005 (JP) 2005-064208

(51) Int. Cl. H04H 1/00; H04M 3/16; H04M 1/68

(52) U.S. Cl. 455/3.01; 455/410

(57) ABSTRACT

A communication terminal is provided that enables one communication terminal to share with another communication terminal information relating to broadcast data such as broadcast content and broadcast usage restriction information received by the aforementioned one communication terminal. In a portable terminal 101 that is a communication terminal, a broadcast data receiving section 201 receives broadcast data to which is attached usage restriction information that restricts the use of broadcast data, a content management section 210 manages transferability/non-transferability of the broadcast data to another communication terminal based on the usage restriction information, and a content transmitting/receiving section 221 transmits the broadcast data to another communication terminal in accordance with management by the content management section 210.

### BACKGROUND OF THE INVENTION

1. Field of the Invention

The present invention relates to a communication terminal that transmits broadcast data for which there are usage restrictions, to another communication terminal.

2. Description of the Related Art

In recent years, high-performance portable terminals equipped with high-resolution liquid crystal displays, high-quality imaging devices, and so forth, have become widespread, and in line with this a variety of applications such as Internet connection, mail transmission and reception, video telephony, and analog TV (Television) broadcast reception have come to be provided in portable terminals in addition to ordinary speech communication.

Also, development is proceeding on portable terminals supporting terrestrial digital TV broadcasting for portable terminals scheduled to begin service in 2005. For example, the “Nippon Electronics” No.866 Cover Story by Hiroki Yomogida and Chikafumi Horikiri, Nikkei BP Corp., 2/2/2004 edition, pages 91 to 113, presented technological trends relating to portable/mobile reception of digital TV broadcasting in Japan and overseas, and introduced prototypes capable of receiving digital TV broadcasting for portable terminals.

Against this background, technologies relating to portable terminals capable of receiving digital TV broadcasting have been disclosed. For example, a portable terminal with a digital recording function enabling the coexistence of two applications for speech communication and digital TV broadcast viewing has been disclosed (see Unexamined Japanese Patent Publication No.2003-348510). According to this, viewing data is stream-recorded during a call, and it is possible to select playback of the relevant recorded data or real-time viewing after the call ends.

Furthermore, methods have been disclosed for communicating TV broadcast data using a conventional mobile communication system. For example, an arrangement has been shown whereby TV broadcast data from a broadcasting station is transmitted to a base station control station within a mobile communication system, and after the transmission format is converted to a format for mobile communication, is transmitted to portable terminals via a base station (see Unexamined Japanese Patent Publication No.2004-40531).

However, with a conventional portable terminal, viewing or recording/playback of broadcast data transmitted from a broadcasting station, including digital TV broadcast data, in the portable terminal itself is presupposed, and other-station transmission whereby the portable terminal transmits to another portable terminal using an existing mobile phone function such as video telephony communication has not been considered. Consider, for example, a case in which portable terminal A used by user A is within a broadcasting area, and portable terminal B used by user B is outside the broadcasting area. When user A is viewing a broadcast using portable terminal A, user A cannot transmit the broadcast data viewed by user A to user B's portable terminal B in real time. Although broadcast data that has been recorded may be transmitted using data communication by means of a mail attachment, the real-time aspect is lost, and the functions necessary for user B's portable terminal depend on the format of the recorded data.

### SUMMARY OF THE INVENTION

It is therefore an object of the present invention to provide a communication terminal that enables one communication terminal to share with another communication terminal information relating to broadcast data such as broadcast content and broadcast usage restriction information received by the aforementioned one communication terminal.

The present invention achieves the above object by employing a configuration comprising: a broadcast data receiving section that receives broadcast data to which is attached usage restriction information that defines usage restrictions relating to the broadcast data; a content management section that manages transferability and non-transferability of the broadcast data to another communication terminal based on the usage restriction information; and a transmitting section that transmits the broadcast data to said another communication terminal in accordance with management by the content management section.

### BRIEF DESCRIPTION OF THE DRAWINGS

The above and other objects and features of the invention will appear more fully hereinafter from a consideration of the following description taken in conjunction with the accompanying drawings in which:

FIG. 1 is a drawing illustrating transmission of broadcast data between portable terminals;

FIG. 2 is a block diagram showing an example of the configuration of a portable terminal provided with a broadcast reception function and video telephony function according to Embodiment 1 of the present invention;

FIG. 3 is a block diagram showing an example of the configuration of a content management section of Embodiment 1;

FIG. 4 is a drawing showing an example of usage restriction information;

FIG. 5 is a drawing showing an example of a home-station ID list;

FIG. 6 is a drawing showing an example of a home-station management list;

FIG. 7 is a drawing showing an example of an other-station ID list;

FIG. 8 is a drawing showing an example of an other-station management list;

FIG. 9 is a flowchart showing an example of transferability/non-transferability determination processing operations in a home-station terminal;

FIG. 10 is a flowchart showing an example of broadcast data transfer start processing operations in a home-station terminal;

FIG. 11 is a flowchart showing an example of broadcast data reception preprocessing operations in an other-station terminal;

FIG. 12 is a flowchart showing an example of broadcast data reception start processing operations in an other-station terminal;

FIG. 13 is a flowchart showing an example of operations that update a home-station management list and other-station management list in a home-station terminal;

FIG. 14 is a flowchart showing an example of operations that update an other-station management list in an other-station terminal; and

FIG. 15 is a block diagram showing an example of the configuration of a portable terminal of Embodiment 2 of the present invention.

### DETAILED DESCRIPTION OF THE PREFERRED EMBODIMENTS

With reference now to the accompanying drawings, embodiments of the present invention will be explained in detail below. In these embodiments, a portable terminal will be used as an example of a communication terminal in the descriptions.

### Embodiment 1

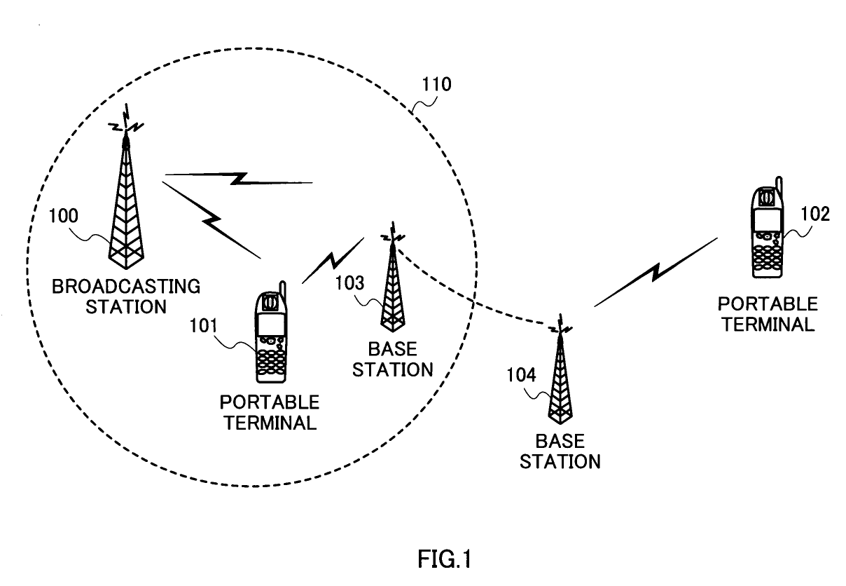

FIG. 1 is a drawing illustrating transmission of broadcast data between portable terminals. FIG. 1 shows an example in which broadcast data is transmitted from a portable terminal 101 to a portable terminal 102. A broadcasting station 100 transmits broadcast data.

“Broadcast data” refers to data broadcast based on the Broadcast Law, and denotes data on which restrictions are imposed on its usage. Restrictions relating to usage are assumed to be imposed by means of usage restriction information attached to broadcast data.

“Information relating to broadcast data” refers to information for managing broadcast data, transmitted together with broadcast data, and includes usage restriction information but excludes parts of broadcast data to be viewed. In this embodiment, a case is described by way of example in which usage restriction information is shared by a plurality of portable terminals as information relating to broadcast data.

“Usage restriction information” defines restrictions regarding the use of broadcast data.

These include, for example, whether or not transfer of broadcast data is possible, and the number of times copying is possible.

Portable terminal 101 is provided with a broadcast reception function and a video telephony function.

Here, “broadcast reception” means receiving broadcast data transmitted from broadcasting station 100. An example of broadcast data is digital TV broadcast data for mobile phones. Broadcasting for portable terminals is to begin around December 2005. Broadcast data transmitted from broadcasting station 100 is received by portable terminal 101, and can be viewed by the user. Broadcast reception is basically unrelated to communication between portable terminals. Broadcast reception includes TV broadcast reception and digital TV broadcast reception.

“Video telephony” refers to the ability to perform simultaneous real-time communication of video/voice between portable terminals—for example, the ability to see the other party's face during a call.

Portable terminal 102 is provided with at least a video telephony function. Whether or not a broadcast reception function is provided is irrelevant.

Base station 103 and base station 104 relay communications of portable terminals (for example, portable terminal 101 and portable terminal 102).

Broadcast reception area 110 indicates the area in which broadcast data transmitted from broadcasting station 100 can be received. FIG. 1 shows a case in which portable terminal 101 is within broadcast reception area 110 and portable terminal 102 is outside broadcast reception area 110. The flow of other-station transmission of broadcast data-that is, transmission of broadcast data to another station-will now be described using FIG. 1.

Broadcast data transmitted from broadcasting station 100 is received by portable terminal 101. Portable terminal 101 transmits broadcast data to portable terminal 102 outside the broadcast reception area via base station 103 and base station 104 using a video telephony function. At this time, portable terminal 101 transmits broadcast data to portable terminal 102 using a video telephony communication protocol. By this means, it is possible for broadcast data transmitted from broadcasting station 100 to be viewed on portable terminal 102 by having that data transferred to portable terminal 102.

In the following description, portable terminal 101 which receives broadcast data and transfers received broadcast data to portable terminal 102 is referred to as the “home-station terminal,” and portable terminal 102 to which broadcast data is transferred is referred to as the “other-station terminal” (or “other portable terminal”). When the term “portable terminal” alone is used, no distinction is made between home-station terminal and other-station terminal.

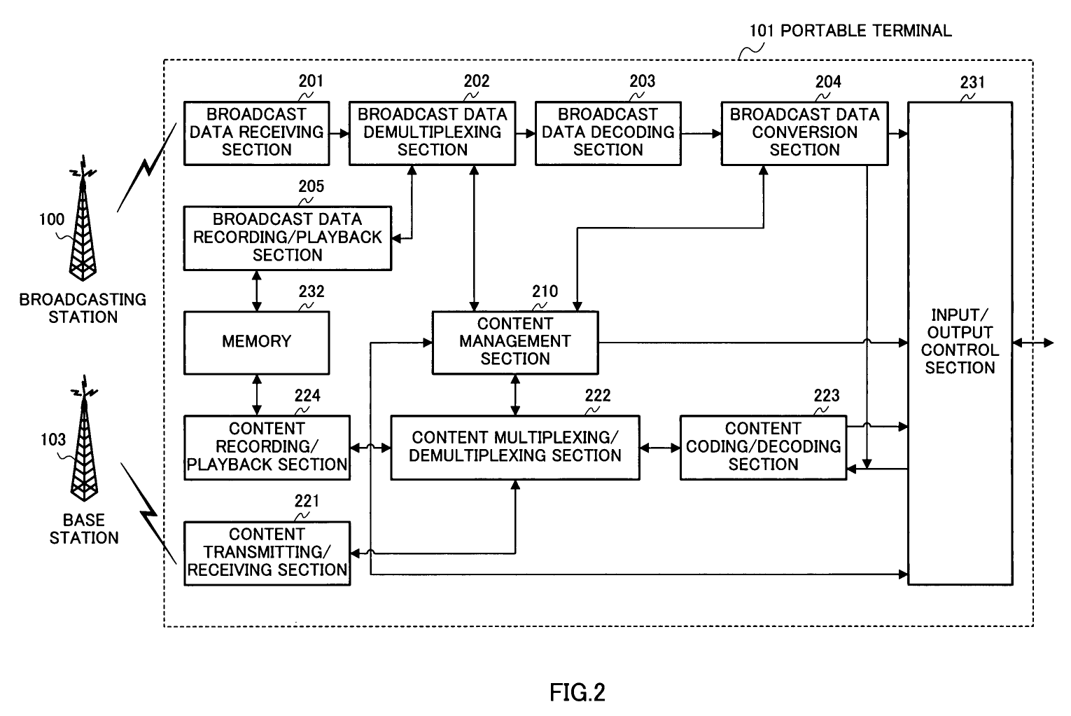

FIG. 2 is a block diagram showing an example of the configuration of a portable terminal provided with a broadcast reception function and video telephony function according to Embodiment 1 of the present invention. In this embodiment, a presupposition is made that the configuration shown in FIG. 2 is provided in both portable terminal 101, which is the home-station terminal, and portable terminal 102, which is the other-station terminal.

In order to implement a broadcast reception function, portable terminal 101 shown in FIG. 2 is provided with a broadcast data receiving section 201, a broadcast data demultiplexing section 202, a broadcast data decoding section 203, a broadcast data conversion section 204, and a broadcast data recording/playback section 205.

Also, in order to implement a video telephony function, portable terminal 101 is provided with a content transmitting/receiving section 221, a content multiplexing/demultiplexing section 222, a content coding/decoding section 223, and a content recording/playback section 224.

Furthermore, a content management section 210 is provided in order to manage broadcast data usage restriction information.

In addition, an input/output control section 231 and memory 232 are provided. In FIG. 2, input/output apparatuses used by the user (such as keys, a screen, a speaker, and a microphone, for example) are omitted.

Broadcast data receiving section 201 receives broadcast data transmitted from broadcasting station 100, and performs baseband processing.

Broadcast data demultiplexing section 202 performs stream demultiplexing of received data for each type of data contained in the received data, such as audio data, video data, text data, and control data. Broadcast data demultiplexing section 202 extracts usage restriction information accompanying broadcast data, and reports this information to content management section 210.

Broadcast data decoding section 203 decodes broadcast data coded by broadcasting station 100. Decoding is executed for each of audio, video, and data broadcast data.

Broadcast data conversion section 204 converts the data format of decoded broadcast data to a data format that can be processed in portable terminal 101. Data format conversion is not performed if not necessary. For example, when broadcast data is viewed, data conversion is unnecessary, and broadcast data is output as-is to input/output control section 231. When broadcast data is transferred to an other-station terminal using the video telephony function, data conversion is necessary, and broadcast data whose data format has been converted is output to content coding/decoding section 223. Broadcast data transfer is started on reception of a directive from content management section 210.

Broadcast data recording/playback section 205 records received broadcast data. Stream-state broadcast data from broadcast data demultiplexing section 202 is input, and recorded in memory 232. Also, although not shown in FIG. 2, if the amount of processing permits, it is possible for broadcast data recording/playback section 205 to record data in memory after performing re-encoding following decoding. Furthermore, when broadcast data is played back, broadcast data recording/playback section 205 reads broadcast data recorded in memory 232 and transfers it to broadcast data demultiplexing section 202. Thereafter, the same kind of processing is performed as when broadcast data is received as described above.

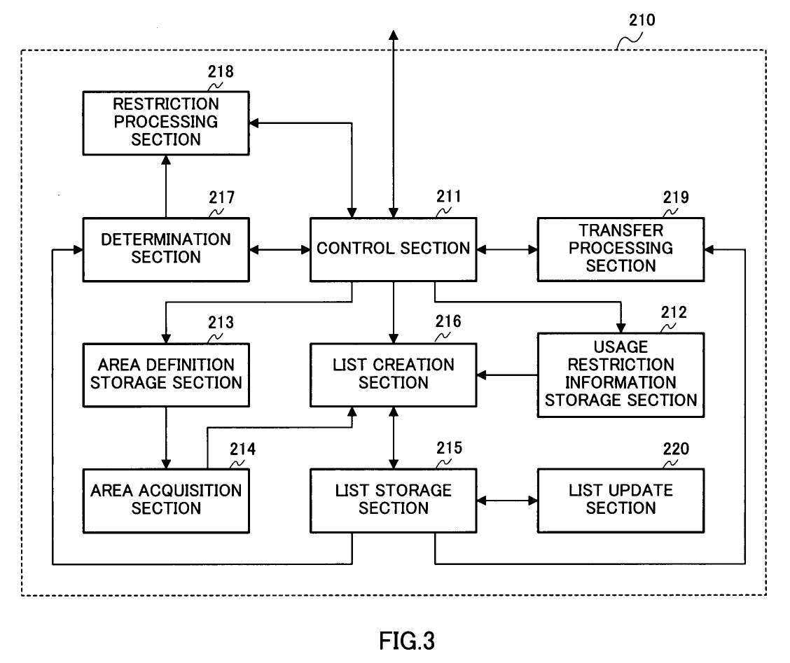

Content management section 210 analyzes usage restriction information extracted from the received broadcast data, and performs management for transmitting broadcast data to the other-station terminal based on the results of the analysis. This will be described in detail later herein using FIG. 3. “Content” refers to data transmitted or received by portable terminal 101, and includes data that can be manipulated by portable terminal 101 such as broadcast data, image data (still image or video), voice data, and text data.

Content transmitting/receiving section 221 transmits broadcast data to an other-station terminal, and also receives data transmitted from the other-station terminal. Content transmitting/receiving section 221 executes baseband processing of transmitted and received data—for example, signal processing such as pre-modulation channel coding and post-demodulation channel decoding processing.

Content multiplexing/demultiplexing section 222 performs multiplexing or demultiplexing of content, demultiplexing video telephony communication data (multiplex data comprising audio data and video data) in reception, and multiplexing audio data and video data into video telephony communication data in transmission.

Content coding/decoding section 223 codes or decodes content, and, more specifically, performs coding (compression) and decoding (decompression) of above-described audio data and video data, and so forth.

Content recording/playback section 224 performs input/output of content to/from memory 232.

Input/output control section 231 controls input/output devices (keys, display screen, microphone, speaker, camera, and so on).

Memory 232 is a storage area that stores content, control information relating to portable terminal 101, and so on.

Although not shown explicitly in FIG. 2, the configuration elements of portable terminal 101 execute their respective functions based on the control of a CPU (Central Processing Unit).

Next, the flow of broadcast data, received data, and transmitting data in FIG. 2 will be described.

Broadcast data is transmitted from broadcasting station 100 and received by broadcast data receiving section 201, and is transferred to input/output control section 231 via broadcast data demultiplexing section 202, broadcast data decoding section 203,and broadcast data conversion section 204.

Received data is transmitted from base station 103 and received by content transmitting/receiving section 221, and is transferred to input/output control section 231 via content multiplexing/demultiplexing section 222 and content coding/decoding section 223.

Transmitting data is transferred to content coding/decoding section 223 from input/output control section 231 or broadcast data conversion section 204, and is transmitted to base station 103 from content transmitting/receiving section 221 via content multiplexing/demultiplexing section 222.

When content of received data or the like is recorded, it is recorded in memory 232 via content multiplexing/demultiplexing section 222 and content recording/playback section 224. Recording may be performed after re-encoding and data multiplexing following data demultiplexing and decoding as in the case of broadcast data. When data recorded in memory 232 is played back, content recording/playback section 224 reads the desired content from memory 232, and reports this to content multiplexing/demultiplexing section 222. Thereafter, the same kind of processing is performed as for received data as described above.

FIG. 3 is a block diagram showing an example of the configuration of content management section 210 of this embodiment.

Content management section 210 includes a control section 211, a usage restriction information storage section 212, an area definition storage section 213, an area acquisition section 214, a list storage section 215, a list creation section 216, a determination section 217, a restriction processing section 218, a transfer processing section 219, and a list update section 220.

Control section 211 receives data from a configuration element outside content management section 210 and transfers the data to a configuration element that processes the data. Control section 211 also transfers data transferred from configuration elements in content management section 210 to a related configuration element. In addition, control section 211 receives usage restriction information from broadcast data demultiplexing section 202 and writes this information to usage restriction information storage section 212. Furthermore, control section 211 controls the operation of the configuration elements of content management section 210.

Usage restriction information storage section 212 is a storage area that stores usage restriction information.

Area definition storage section 213 stores an area definition list provided by a broadcast provider beforehand. An area definition list specifies the ranges of a plurality of areas. For example, an area definition list is composed of area IDs (area identifiers) assigned to the ranges of a plurality of areas, and latitudes and longitudes that specify the ranges corresponding to the respective area IDs. An area definition list is written to area definition storage section 213 when a user concludes a broadcast data reception contract with a broadcast provider.

Area acquisition section 214 acquires position information (latitude and longitude) indicating the position of portable terminal 101 using a position acquisition function provided in portable terminal 101, references the position information and area definition list, and acquires the individual area ID of portable terminal 101 at the point in time at which the position information was acquired. GPS (Global Positioning System) or the like is used as the position acquisition function.

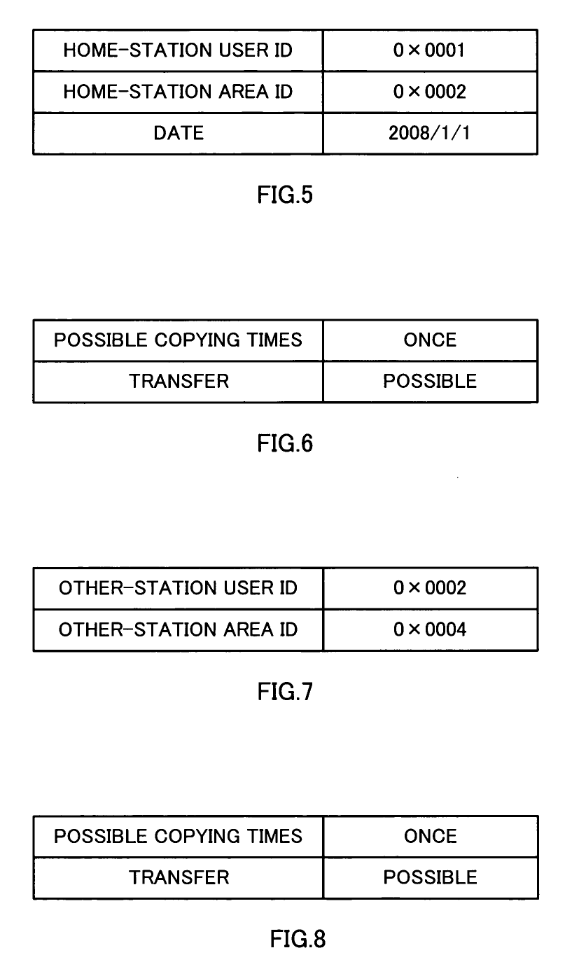

List storage section 215 is a storage area that stores usage restriction lists. List creation section 216 creates usage restriction lists. The contents and creation of usage restriction lists will be described later herein using FIG. 5 through FIG. 12.

Based on the usage restriction lists, determination section 217 determines whether or not broadcast data is to be transferred to the other-station terminal, and reports the determination result and usage restriction list(s) to restriction processing section 218.

Restriction processing section 218 performs processing to execute broadcast data-related restrictions in accordance with the restriction contents included in the usage restriction lists. Processing is performed when the determination result and usage restriction lists are reported from determination section 217, when a usage restriction list is transferred from list update section 220, and so forth. For example, control data is reported to input/output control section 231 in order to be reflected in a user operation or the like. Also, inter-terminal authentication processing for performing authentication with respect to the other-station terminal, security processing for performing security related control, data erasure processing that performs data erasing by means of a copy-once function, and so forth are executed. In inter-terminal authentication processing, it is necessary for control data to be multiplexed with data supported by the video telephony function using the H.223 protocol or the like, and communication with content multiplexing/demultiplexing section 222 is performed for this purpose.

Transfer processing section 219 instructs broadcast data conversion section 204 that broadcast data being received is to be transferred to an other-station terminal.

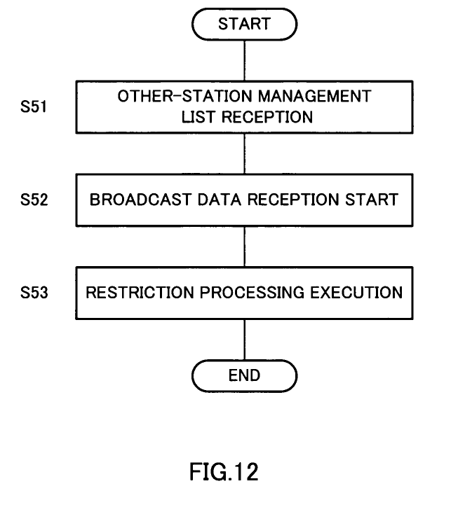

List update section 220 updates usage restriction lists stored in list storage section 215. Together with usage restriction list updating, restriction processing section 218 is instructed to execute restriction processing. List update section 220 processing will be described in detail later herein using FIG. 11 and FIG. 12.

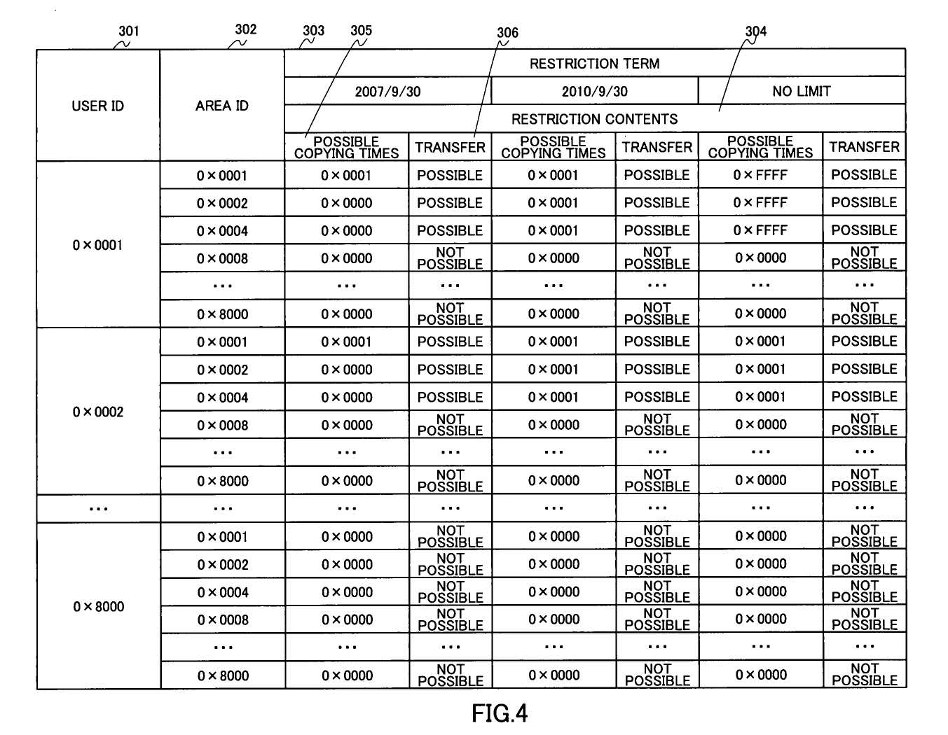

Usage restriction information will now be described. FIG. 4 is a drawing showing an example of usage restriction information. The usage restriction information shown in FIG. 4 includes user ID (user identifier) 301, area ID 302, restriction term 303, restriction contents 304, possible copying times 305, and transfer 306.

User ID 301 specifies a user who uses broadcast data. The broadcast provider assigns each user in advance an individual user ID to be used by that user. User ID 301 is defined as 0x0001 through 0x8000, and managed in individual bit units. Thus, 16 groups are defined for the entire number of bits.

Area ID 302 specifies the range of places in which a user uses broadcast data. Area ID 302 is managed on a bit basis in the same way as user ID 301, and is defined as 16 groups. The ranges of areas of a plurality of area IDs are given correspondence in the area definition list. Therefore, an individual area ID that specifies a place at which a portable terminal is located is decided uniquely in accordance with the place at which the portable terminal is located.

Restriction term 303 shows an expiration term of restriction contents 304. In FIG. 4, restriction term 303 shows the expiration date of restrictions in the same column of the list.

Restriction contents 304 shows details of restrictions applying to the use of broadcast data. In FIG. 4, restriction contents are defined for each restriction term 303. The restriction contents shown in FIG. 4 are only one example, and items other than possible copying times 305 and transfer 306 may be specified.

Possible copying times 305 shows the number of times copying is possible by a portable terminal that receives broadcast data (a portable terminal being an example of a communication terminal). Under possible copying time 305, 0xFFFF means that there is no restriction on the number of times, and a value other than 0xFFFF is a numerical representation of the number of times copying is possible.

Transfer 306 shows as a “Possible” or “Not possible” entry whether or not it is possible for a portable terminal that receives broadcast data to transfer data to an other-station terminal using a video telephony function.

Consider, for example, a case in which a user is assigned 0x0001 as an individual user ID by a broadcast provider. If present in an area for which area ID 302 is defined as 0x0001, the user can copy received broadcast data only once, and transfer of received broadcast data is possible, up until 9/30/2007. Also, from 10/1/2010 onward, there is no longer any restriction on the number of times copying can be performed. If present in an area for which area ID 302 is defined as 0x0008, the user cannot copy or transfer received broadcast data, and this also applies from 10/1/2010 onward.

Next, usage restriction lists will be described using FIG. 5 through FIG. 8. When the home-station terminal transfers received broadcast data to the other-station terminal, usage restriction lists are created to manage the use of broadcast data based on usage restriction information, and are stored in list storage section 215 (FIG. 3). Usage restriction lists includes a home-station ID list (FIG. 5), a home-station management list (FIG. 6), an other-station ID list (FIG. 7), and an other-station management list (FIG. 8).

FIG. 5 is a drawing showing an example of a home-station ID list. A home-station ID list includes a home-station user ID, home-station area ID, and date. Home-station user ID is the individual user ID of the home-station terminal, home-station area ID is an individual area ID showing the area in which the home-station terminal is located, and date is the current date. The individual user ID assigned to a user is written in when the user concludes a broadcast data reception contract with a broadcast provider.

FIG. 6 is a drawing showing an example of a home-station management list. A home-station management list includes possible copying times, and transfer. Using the information stored in FIG. 5, the usage restriction information shown in FIG. 4 is searched, and restriction information corresponding to home-station user ID, home-station area ID, and date is extracted and stored in the home-station management list. The home-station management list in FIG. 6 shows that copying is possible one time, and transfer is possible. The restriction contents items shown in FIG. 6 are one example, corresponding to the restriction contents of the usage restriction information (FIG. 4).

FIG. 7 is a drawing showing an example of an other-station ID list. Another-station ID list includes other-station user ID and other-station area ID. Other-station user ID is the individual user ID of the other-station terminal, and other-station area ID is an individual area ID showing the area in which the other-station terminal is located.

FIG. 8 is a drawing showing an example of an other-station management list. An other-station management list includes possible copying times and transfer. Using the information stored in FIG. 7, the usage restriction information shown in FIG. 4 is searched, and restriction information corresponding to other-station user ID and other-station area ID, as well as date in the home-station ID list in FIG. 5, is extracted and stored in the other-station management list. The other-station management list in FIG. 8 shows that copying is possible one time, and transfer is possible. The restriction contents items shown in FIG. 8 are one example, corresponding to the restriction contents of the usage restriction information (FIG. 4).

Content management section 210 manages broadcast data using the home-station management list and other-station management list.

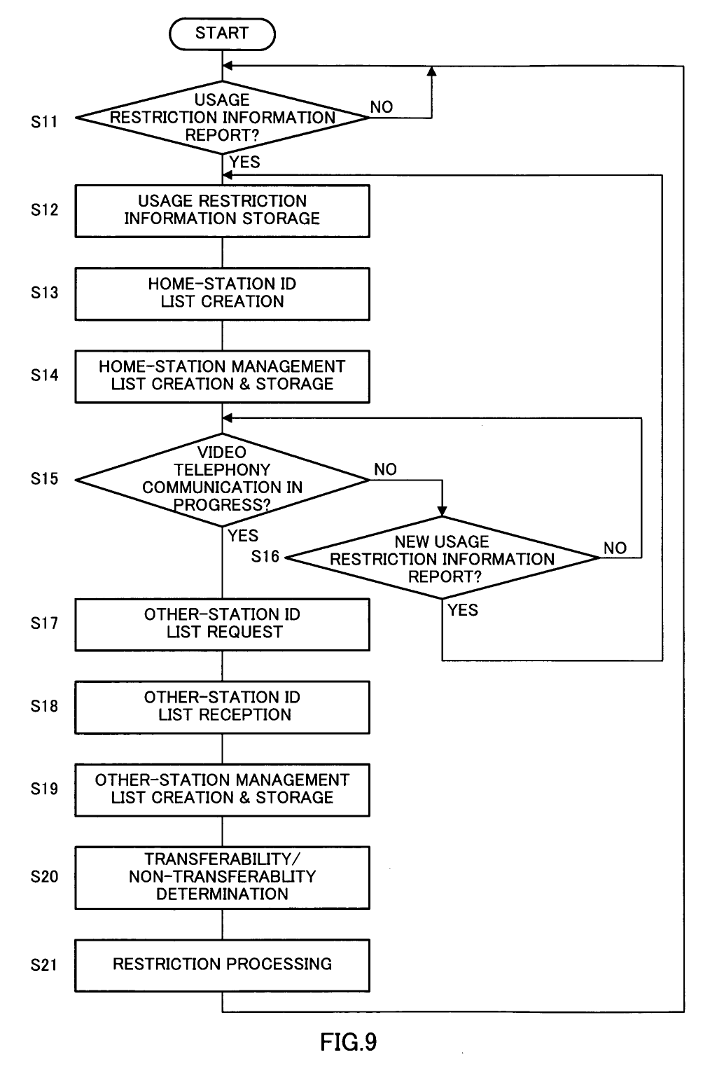

Next, using the block diagram in FIG. 3 and the flowcharts in FIG. 9 through FIG. 12, broadcast data transferability/non-transferability determination processing and broadcast data transfer start processing in a home-station terminal, and pre-reception processing and broadcast data reception start processing in an other-station terminal, will be described for a case in which broadcast data is transferred from the home-station terminal to the other-station terminal.

FIG. 9 is a flowchart showing an example of transferability/non-transferability determination processing operations in a home-station terminal. Broadcast data transferability/non-transferability determination processing is executed by content management section 210 in the home-station terminal.

Control section 211 is in a waiting state until usage restriction information is reported from broadcast data demultiplexing section 202 (NO in S11). When broadcast data receiving section 201 newly starts reception of broadcast data, usage restriction information is reported to control section 211 of content management section 210 at the timing at which broadcast data demultiplexing section 202 extracts usage restriction information from the broadcast data.

When usage restriction information is reported (YES in S11), control section 211 stores the reported usage restriction information in usage restriction information storage section 212, and gives a directive for list creation to list creation section 216 (S12).

List creation section 216 creates a home-station ID list (FIG. 5) (S13). Specifically, list creation section 216 gives a directive for home-station terminal individual area ID acquisition to area acquisition section 214, and writes the acquired individual area ID and the current time to a home-station ID list. Then list creation section 216 searches for usage restriction information using the home-station ID list, extracts restriction contents corresponding to the home-station terminal, creates a home-station management list (FIG. 6), and writes the created home-station ID list and home-station management list to list storage section 215 (S14).

Next, if video telephony communication with the other-station terminal has not been started (NO in S15), control section 211 determines whether new usage restriction information has not been reported. This is because, when the user switches the broadcast channel, new broadcast data is received, and usage restriction information also changes to new information. When new usage restriction information is reported (YES in S16) control section 211 repeats the processing from S12. If new usage restriction information is not reported (NO in S16), control section 211 repeats the processing from S15 until video telephony communication with the other-station terminal is started, and waits for video telephony communication to start (repeating S15 and S16).

On the other hand, if video telephony communication with the other-station terminal has been started (YES in S15), list creation section 216 makes a request to the other-station terminal for other-station ID list (FIG. 7) transmission via control section 211 (S17). Upon receiving an other-station ID list via control section 211 (S18), list creation section 216 creates an other-station management list (FIG. 8) using the received other-station ID list and usage restriction information, and writes the other-station ID list and other-station management list to list storage section 215 (S19).

Determination section 217 then determines whether or not broadcast data transfer is possible using the home-station management list (S20). If the transfer entry in the home-station management list is “Possible”, transfer is determined to be possible. Restriction processing section 218 then executes restriction processing based on the restriction contents of the home-station management list (S21). Restriction processing section 218 performs specific key operation locking, LCD (Liquid Crystal Display) display, and suchlike key/display control as necessary. For example, if broadcast data transfer is not possible, processing is performed to lock a key by means of which the user designates broadcast data transfer, and if the number of times copying is possible is 0, an operation is executed to lock a key designating copying and so prevent operation of that key by the user.

Broadcast data transferability/non-transferability determination processing is started at the same time as broadcast data reception by the home-station terminal, and ends with the end of broadcast reception.

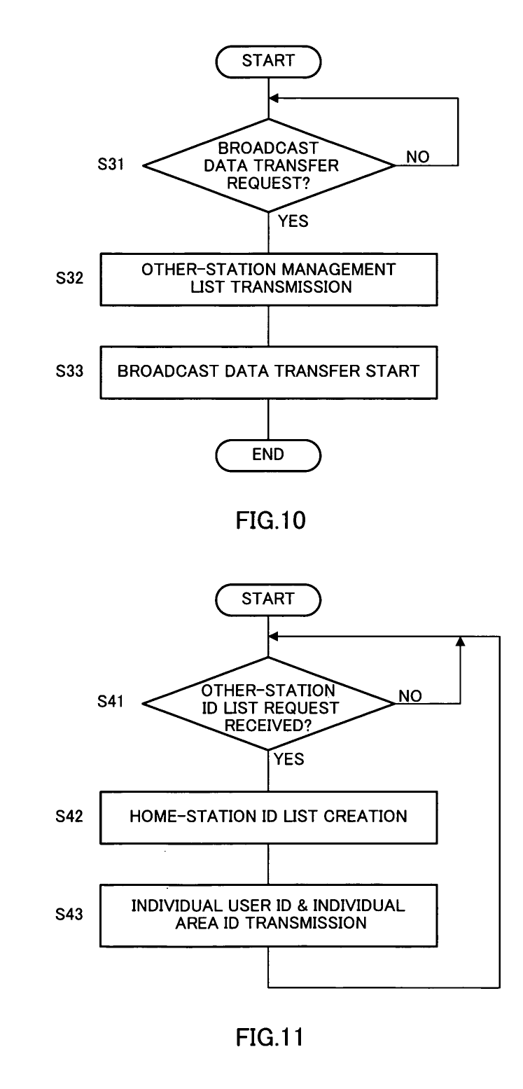

Broadcast data transfer start processing will now be described. FIG. 10 is a flowchart showing an example of broadcast data transfer start processing operations in a home-station terminal. Broadcast data transfer start processing is executed by content management section 210 of the home-station terminal when transmission is determined to be possible in broadcast data transferability/non-transferability determination processing (FIG. 9). Broadcast data transfer start processing is started when an operation whereby broadcast data transfer is requested by the home-station terminal user (a user operation such as a key operation) is input to input/output control section 231. Control section 211 waits for a transfer request until broadcast data transfer request operation is performed by the user (NO in S31)

When broadcast data transfer is requested, input/output control section 231 reports the start of broadcast data transfer to control section 211 of content management section 210, and control section 211 reports the start of transfer processing to transfer processing section 219 (YES in S31). Transfer processing section 219 reads the other-station management list from list storage section 215, and transmits the read other-station management list to the other-station terminal via content transmitting/receiving section 221 (S32). Transfer processing section 219 then instructs broadcast data conversion section 204 to start broadcast data transfer (S33).

When data transmission/reception is performed with respect to the other-station terminal during video telephony in the processing flow in FIG. 9 and FIG. 10, data transfer is performed between content management section 210 and content multiplexing/demultiplexing section 222, and in data transmitted/received by video telephony, control data is multiplexed using the H.223 protocol or the like.

Next, broadcast data reception preprocessing in the other-station terminal will be described. FIG. 1l is a flowchart showing an example of broadcast data pre-reception processing operations in an other-station terminal. Upon receiving an other-station ID list request from the home-station terminal (YES in S41), control section 211 of content management section 210 in the other-station terminal gives a directive for home-station ID list creation to list creation section 216, and list creation section 216 creates a home-station ID list (S42). Home-station ID list creation is the same as in the home-station terminal, and therefore a description thereof is omitted here. List creation section 216 transmits an individual user ID and individual area ID via control section 211, and also content multiplexing/demultiplexing section 222 and content transmitting/receiving section 221 (S43).

Next, broadcast data reception start processing in the other-station terminal will be described. FIG. 12 is a flowchart showing an example of broadcast data reception start processing operations in an other-station terminal. Control section 211 receives an other-station management list from the home-station terminal via content transmitting/receiving section 221 and content multiplexing/demultiplexing section 222. Control section 211 writes the received other-station management list to list storage section 215 (S51). Next, content transmitting/receiving section 221 starts broadcast data reception (S52). Control section 211 then gives a directive for execution of restriction processing to restriction processing section 218 based on the received other-station management list. Restriction processing section 218 executes restriction processing based on the restriction contents of the other-station management list. More specifically, restriction processing section 218 performs specific key operation locking, LCD display, and suchlike key/display control and so forth as necessary.

As described above, it is possible for a home-station terminal having a broadcast reception function to transmit broadcast data being received to an other-station terminal engaged in video telephony communication in accordance with the processing shown in FIG. 9 and FIG. 10, and for the other-station terminal to receive broadcast data as video telephony received data (content) in accordance with the processing shown in FIG. 1 and FIG. 12. Therefore, it is not necessary for the other-station terminal to be provided with a broadcast reception function, and a portable terminal having a conventional video telephony function can be used.

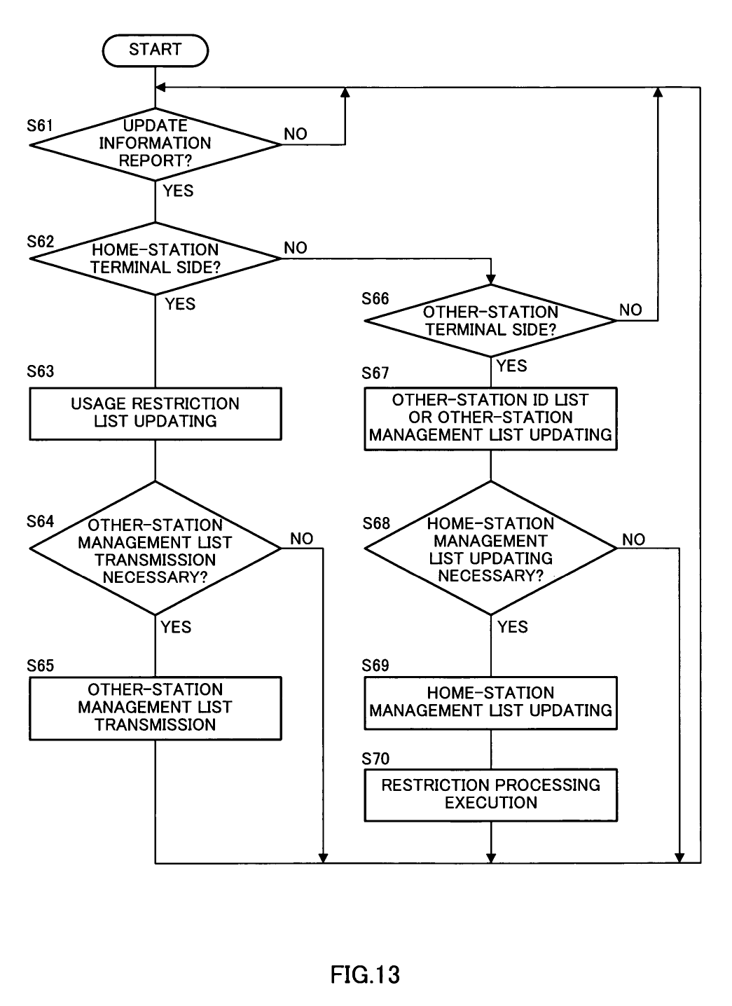

The procedure for performing usage restriction list updating will now be described. Usage restriction list updating is performed as necessary by copy execution, or the occurrence of a change of the area in which a portable terminal is located, or the like. FIG. 13 is a flowchart showing an example of operations that update a home-station management list and other-station management list in a home-station terminal.

When there is information for performing usage restriction list updating with in a home-station terminal, or in an other-station terminal, the home-station terminal receives an update information report. For example, in the home-station terminal, when a key designating copying of broadcast data is pressed by the user, update information is reported to control section 211. Upon receiving an update information report (YES in S61), control section 211 transfers the update information to list update section 220. Update information includes terminal information indicating whether the source of the update information is the home-station terminal or other-station terminal, item information indicating an item to be updated, and contents information indicating update contents. Possible update items are the number of times copying is possible (“possible copying times”), the area ID (“area ID”), and so forth. Here, an example will be described in which the number of times copying is possible is decreased because one terminal or other has executed copying.

If the terminal information indicates the home-station terminal (YES in S62), list update section 220 references the usage restriction lists and updates the relevant place (S63). If for example, the item information indicates possible copying times, and contents information indicates that the number of times copying is possible is 1, possible copying times is decremented in the home-station management list and other-station management list. If the item information indicates the home-station area ID, and the contents information indicates a new home-station individual area ID, the home-station area ID in the home-station ID list is rewritten. When the area ID changes, and when a change is necessary in the home-station management list, the home-station management list is recreated.

Next, list update section 220 determines whether it is necessary to transmit the other-station management list to the other-station terminal (S64). For example, transmission is necessary when possible copying times is changed. If other-station management list transmission is determined to be necessary (YES in S64), list update section 220 transmits the other-station management list (S65). This applies, for example, to a case in which, while both the home-station terminal and other-station terminal are viewing broadcast data with a copy-once restriction, if the home-station terminal starts recording, recording becomes impossible for the other-station terminal.

If the terminal information does not indicate the home-station terminal (NO in S62), list update section 220 confirms whether this is update information from the other-station terminal (YES in S66), and as in S63, references the other-station ID list or other-station management list among the usage restriction lists, and updates the relevant place (S67). Then, if home-station management list (or home-station ID list) updating is determined to be necessary (YES in S68), list update section 220 updates the home-station management list (or home-station ID list) (S69). List update section 220 also gives a directive for execution of restriction processing in accordance with the changed restriction contents to restriction processing section 218 via control section 211 as necessary (S70).

If list update section 220 determines that this is not update information from the other-station terminal (NO in S66), the processing flow returns to S61.

When an area ID is changed, a management list change is necessary. When a management list change is made, there is an update information report, and the home-station or other-station management list is always updated.

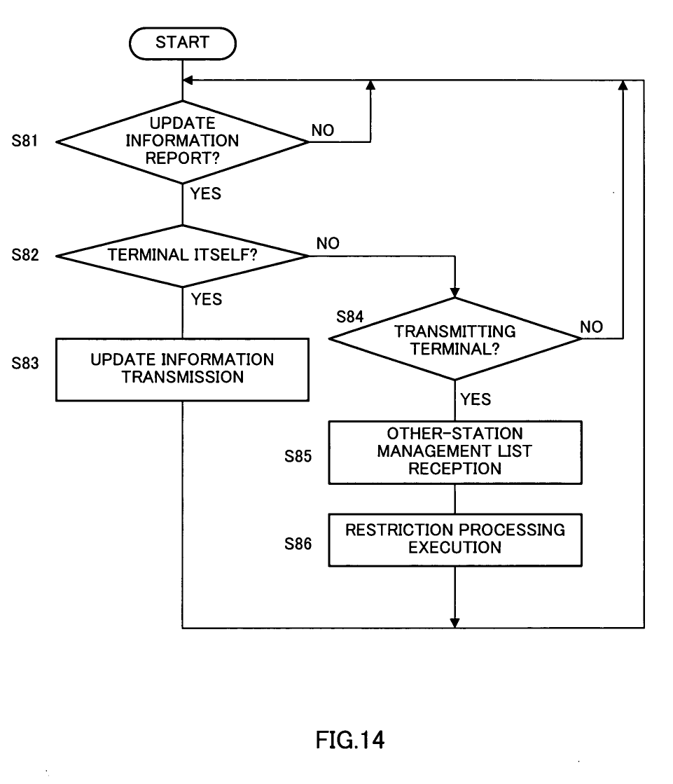

The procedure for updating an other-station management list of an other-station terminal will now be described. FIG. 14 is a flowchart showing an example of operations that update an other-station management list in an other-station terminal. In the following description, a home-station terminal and other-station terminal are used, but since the explanation would be difficult to understand if “other-station terminal” were made the subject, the other-station terminal is referred to as the “terminal itself (other-station terminal).” The term “transmitting terminal (home-station terminal)” is also used.

When there is information for performing usage restriction list updating within an other-station terminal, or in the home-station terminal, the other-station terminal receives an update information report. Upon receiving an update information notification (YES in S81), control section 211 transfers the update information to list update section 220. Update information is the same as described with reference to FIG. 13.

If the terminal information indicates the terminal itself (other-station terminal) (YES in S82), the update information is transmitted to the transmitting terminal (home-station terminal) (S83). On the other hand, if the terminal information does not indicate the terminal itself (other-station terminal) (NO in S82), list update section 220 confirms whether this is update information from the transmitting terminal (home-station terminal) (YES in S84), receives an other-station management list transmitted from the transmitting terminal (home-station terminal), and updates the other-station management list (S85). List update section 220 also gives a directive for execution of restriction processing in accordance with the changed restriction contents to restriction processing section 218 via control section 211 as necessary (S86).

### Embodiment 2

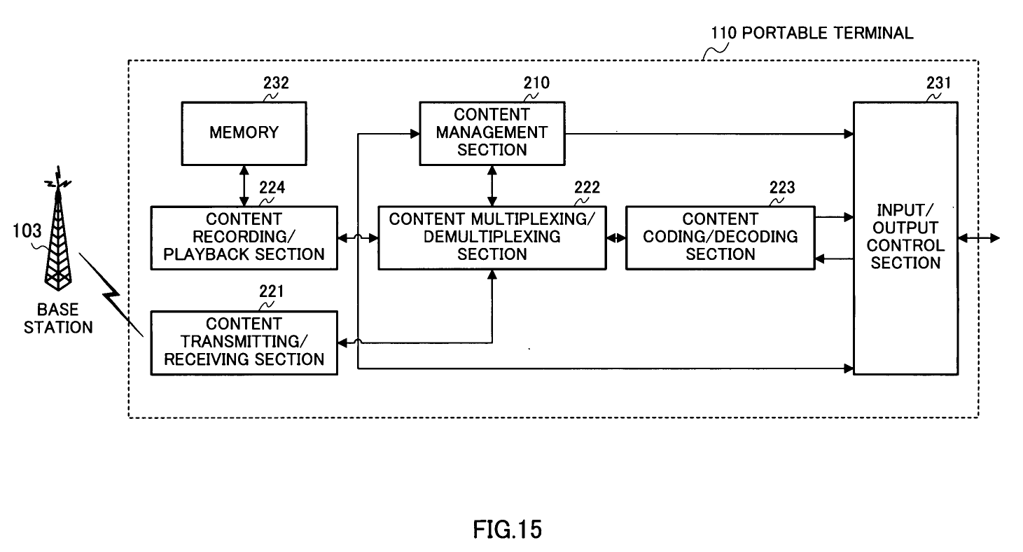

In Embodiment 2, a case is described in which an other-station terminal is not provided with a broadcast reception function. FIG. 15 is a block diagram showing an example of the configuration of a portable terminal of Embodiment 2 of the present invention. Items in FIG. 15 bearing the same codes as in FIG. 2 have the same names and the same kind of functions as in FIG. 2, and therefore detailed descriptions thereof are omitted. Portable terminal 110 in FIG. 15 is equivalent to portable terminal 101 shown in FIG. 2 with the exclusion of the configuration elements that implement a broadcast reception function, and content management section 210 may have the same configuration elements as in FIG. 3. Alternatively, of the configuration elements in FIG. 3, content management section 210 may have control section 211, area definition storage section 213, area acquisition section 214, list storage section 215, list creation section 216, restriction processing section 218, and list update section 220. The operation of portable terminal 110 is also similar to that of portable terminal 101, except for the broadcast reception function, and therefore a description thereof is omitted here.

If portable terminal 110 does not have a reception contract with a broadcasting station, it is possible for broadcast data to be transferred in the case of broadcast data for which there are no transfer-related restrictions in the broadcast data usage restriction information.

Thus, even if an other-station terminal is not provided with a broadcast reception function, as long as it has a video telephony function it is possible for a broadcast to be viewed on the other-station terminal by transferring broadcast data by adding the function of content management section 210 shown in FIG. 3.

In the above-described embodiments, descriptions have been given using a portable terminal as an example of a communication terminal, but it is not necessary for a communication terminal to be limited to a portable terminal, and a communication terminal other than a portable terminal may be used as long as it can receive broadcast data and has a video telephony function. Therefore, communication terminals may use either a radio channel or cable channel, or may communicate partly by cable channel and partly by radio channel. Communication terminals may also be fixed communication terminals. For example, a case is possible in which, in one part of communication, broadcast data is received using a cable channel, and in another part received broadcast data is transferred using a radio channel.

In the above embodiments, also, usage restriction information has been described as broadcast data related information by way of example, but it is also possible for information to be shared among a plurality of communication terminals when that information is other than broadcast data related information.

The present invention is not limited to the above-described embodiments, and various variations and modifications may be possible without departing from the scope of the present invention.

This application is based on Japanese Patent Application No.2005-064208, filed on Mar. 8, 2005, the entire content of which is expressly incorporated by reference herein.

[FIG. 1]
100 BROADCASTING STATION
101 PORTABLE TERMINAL
102 PORTABLE TERMINAL
103 BASE STATION
104 BASE STATION

[FIG. 2]
100 BROADCASTING STATION
103 BASE STATION
101 PORTABLE TERMINAL
201 BROADCAST DATA RECEIVING SECTION
202 BROADCAST DATA DEMULTIPLEXING SECTION
203 BROADCAST DATA DECODING SECTION
204 BROADCAST DATA CONVERSION SECTION
205 BROADCAST DATA RECORDING/PLAYBACK SECTION
210 CONTENT MANAGEMENT SECTION
221 CONTENT TRANSMITTING/RECEIVING SECTION
222 CONTENT MULTIPLEXING/DEMULTIPLEXING SECTION
223 CONTENT CODING/DECODING SECTION
224 CONTENT RECORDING/PLAYBACK SECTION
231 INPUT/OUTPUT CONTROL SECTION
232 MEMORY

[FIG. 3]
211 CONTROL SECTION
212 USAGE RESTRICTION INFORMATION STORAGE SECTION
213 AREA DEFINITION STORAGE SECTION
214 AREA ACQUISITION SECTION
215 LIST STORAGE SECTION
216 LIST CREATION SECTION
217 DETERMINATION SECTION
218 RESTRICTION PROCESSING SECTION
219 TRANSFER PROCESSING SECTION
220 LIST UPDATE SECTION

[FIG. 4]
301 USER ID
302 AREA ID
303 RESTRICTION TERM
NO LIMIT
304 RESTRICTION CONTENTS
305 POSSIBLE COPYING TIMES
306 TRANSFER
POSSIBLE
NOT POSSIBLE

[FIG. 5]
HOME-STATION USER ID
HOME-STATION AREA ID
DATE

[FIG. 6]
POSSIBLE COPYING TIMES ONCE
TRANSFER POSSIBLE

[FIG. 7]
OTHER-STATION USER ID
OTHER-STATION AREA ID

[FIG. 8]
POSSIBLE COPYING TIMES ONCE
TRANSFER POSSIBLE

[FIG. 9]
START
S11 USAGE RESTRICTION INFORMATION REPORT?
S12 USAGE RESTRICTION INFORMATION STORAGE
S13 HOME-STATION ID LIST CREATION
S14 HOME-STATION MANAGEMENT LIST CREATION & STORAGE
S15 VIDEO TELEPHONY COMMUNICATION IN PROGRESS?
S16 NEW USAGE RESTRICTION INFORMATION REPORT?
S17 OTHER-STATION ID LIST REQUEST
S18 OTHER-STATION ID LIST RECEPTION
S19 OTHER-STATION MANAGEMENT LIST CREATION & STORAGE
S20 TRANSFERABILITY/NON-TRANSFERABILITY DETERMINATION
S21 RESTRICTION PROCESSING

[FIG. 10]
START
S31 BROADCAST DATA TRANSFER REQUEST?
S32 OTHER-STATION MANAGEMENT LIST TRANSMISSION
S33 BROADCAST DATA TRANSFER START
END

[FIG. 11]
START
S41 OTHER-STATION ID LIST REQUEST RECEIVED?
S42 HOME-STATION ID LIST CREATION
S43 INDIVIDUAL USER ID & INDIVIDUAL AREA ID TRANSMISSION

[FIG. 12]
START
S51 OTHER-STATION MANAGEMENT LIST RECEPTION
S52 BROADCAST DATA RECEPTION START
S53 RESTRICTION PROCESSING EXECUTION
END

[FIG. 13]
START
S61 UPDATE INFORMATION REPORT?
S62 HOME-STATION TERMINAL SIDE?
S63 USAGE RESTRICTION LIST UPDATING
S64 OTHER-STATION MANAGEMENT LIST TRANSMISSION NECESSARY?
S65 OTHER-STATION MANAGEMENT LIST TRANSMISSION
S66 OTHER-STATION TERMINAL SIDE?
S67 OTHER-STATION ID LIST OR OTHER-STATION MANAGEMENT LIST UPDATING
S68 HOME-STATION MANAGEMENT LIST UPDATING NECESSARY?
S69 HOME-STATION MANAGEMENT LIST UPDATING
S70 RESTRICTION PROCESSING EXECUTION

[FIG. 14]
START
S81 UPDATE INFORMATION REPORT?
S82 TERMINAL ITSELF?
S83 UPDATE INFORMATION TRANSMISSION
S84 TRANSMITTING TERMINAL?
S85 OTHER-STATION MANAGEMENT LIST RECEPTION
S86 RESTRICTION PROCESSING EXECUTION

[FIG. 15]
103 BASE STATION
110 PORTABLE TERMINAL
210 CONTENT MANAGEMENT SECTION
221 CONTENT TRANSMITTING/RECEIVING SECTION
222 CONTENT MULTIPLEXING/DEMULTIPLEXING SECTION
223 CONTENT CODING/DECODING SECTION
224 CONTENT RECORDING/PLAYBACK SECTION
231 INPUT/OUTPUT CONTROL SECTION
232 MEMORY

What is claimed is:

1. A communication terminal comprising:
a broadcast data receiving section that receives broadcast data to which is attached usage restriction information that defines usage restrictions relating to the broadcast data;
a content management section that manages transferability and non-transferability of the broadcast data to another communication terminal based on the usage restriction information; and
a transmitting section that transmits the broadcast data to said another communication terminal in accordance with management by the content management section.

2. The communication terminal according to claim 1, wherein:
the usage restriction information defines the transferability and non-transferability of the broadcast data for each user identifier indicating a broadcast data reception contract; and
the content management section searches for the usage restriction information using its own user identifier, and determines whether or not the broadcast data can be transferred to said another communication terminal.

3. The communication terminal according to claim 1, wherein:
the usage restriction information defines restriction contents that restrict processing relating to the broadcast data;
the content management section further comprises:
a list creation section that searches for the usage restriction information, extracts the restriction contents, and creates a usage restriction list that manages broadcast data processing using the restriction contents;
a list storage section that stores the usage restriction list; and
a determination section that searches for the usage restriction list and determines the transferability and non-transferability of the broadcast data; and
the transmitting section transmits the usage restriction list to said another communication terminal.

4. The communication terminal according to claim 3, wherein:
the content management section further comprises a list update section that, when the broadcast data is processed, updates a usage restriction list stored in the list storage section; and
the transmitting section transmits the updated usage restriction list to said another communication terminal.

5. The communication terminal according to claim 4, wherein the list update section acquires processing contents whereby said another communication terminal has processed the broadcast data, and updates the usage restriction list stored in the list storage section using acquired processing contents.
